(19) United States
(12) Patent Application Publication
(10) Pub. No.: US 2010/0102994 A1
(43) Pub. Date: Apr. 29, 2010

(54) ELECTRONIC APPARATUS AND ELECTRONIC SYSTEM

(75) Inventor: Yukisuke Ozaki, Kobe (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-Shi (JP)

(21) Appl. No.: 12/451,845

(22) PCT Filed: Apr. 30, 2008
(86) PCT No.: PCT/JP2008/058286

§ 371 Date: Dec. 3, 2009

(30) Foreign Application Priority Data
Jun. 6, 2007 (JP) 2007-150978

(51) Int. Cl. G08G 1/123

(52) U.S. Cl. 340/995.26

(57) ABSTRACT

An electronic apparatus from which a portable apparatus having a display can be detached, the electronic apparatus characterized by including: a first output unit that outputs an image signal to the portable apparatus; a second output unit that outputs an image signal to a display apparatus different from the portable apparatus; a detecting unit that detects a detachment of the portable apparatus; and an image processing unit that makes the second output unit continue to output the image signal, and stops the image signal of the first output unit when the detecting unit detects the detachment of the portable apparatus.

### TECHNICAL FIELD

The present invention relates to an electronic apparatus and an electronic system, especially relates to an electronic apparatus and an electronic system to which a portable apparatus having a display portion can be attached.

### BACKGROUND ART

As conventional navigation apparatuses, there are widely known small-sized portable navigation apparatuses with simplified structure and portability (hereinafter, referred to as Portable Navi), also known as personal navigation device; and in-vehicle navigation apparatuses accommodated and fixed in a recess portion (DIN opening) formed in a dashboard of a vehicle. The in-vehicle navigation apparatuses are capable of guiding with high accuracy by use of the information supplied from vehicles such as vehicle speed, and some of the in-vehicle navigation apparatuses are equipped with audio devices.

In recent years, the navigation apparatuses with portability of the Portable Navi and high-accuracy guide function of the in-vehicle navigation apparatus have been studied.

Reference 1 and Reference 2 disclose a configuration where a CD unit can be detached from an in-vehicle apparatus. Reference 3 and Reference 4 disclose a configuration where a navigation portion can be detached from an in-vehicle apparatus mounted in a vehicle. By removing the navigation portion from the in-vehicle apparatus, the navigation portion can be used as a Portable Navi of a single unit. Also, as disclosed in Reference 5, the navigation apparatus is taken out of the vehicle and can be used while walking. In addition, when mounted in a vehicle, the navigation apparatus is in a car-navigation mode, and when taken out of the vehicle, the navigation apparatus is in a person-navigation mode.

[Reference 1] Japanese Patent Application Publication No. 8-318792

[Reference 2] Japanese Patent Application Publication No. 2002-328026

[Reference 3] Japanese Patent Application Publication No. 2005-524570

[Reference 4] Japanese Patent Application Publication No. 2001-239895

[Reference 5] Japanese Patent Application Publication No. 2003-166848

### DISCLOSURE OF THE INVENTION

### Problems to be Solved by the Invention

There is a case that the image that the DVD player provided to the in-vehicle apparatus reproduces is watched on the display portion of a display portable apparatus (e.g. Portable Navi) after the display portable apparatus having a display potion is attached to the in-vehicle apparatus, and the same image is watched on a display apparatus such as the rear seat display portion except the display portable apparatus. In this case, the in-vehicle apparatus transmits the image signal to the display portable apparatus and the rear seat display portion. When the display portable apparatus is detached from the in-vehicle apparatus, the image signal is applied to the output terminal for transmitting the image signal to the display portable apparatus. Therefore, if conductive goods contact the output terminal, a short circuit occurs between terminals. Or, the image signal becomes noise, and leaks. As described above, it is not preferable that the image signal is transmitted to the exposed output terminal. If the output of the image signal is blocked when the display portable apparatus is detached from the in-vehicle apparatus, the image cannot be watched on the rear seat display portion.

The present invention has been made in view of the above circumstances and aims to block the image signal transmitted to the exposed output unit when the display portable apparatus is detached, and to enable the image to be watched on the display apparatus except the display portable apparatus (the rear seat display portion).

### Means for Solving the Problems

The present invention is an electronic apparatus from which a portable apparatus having a display can be detached, the electronic apparatus characterized by including: a first output unit that outputs an image signal to the portable apparatus; a second output unit that outputs an image signal to a display apparatus different from the portable apparatus; a detecting unit that detects a detachment of the portable apparatus; and an image processing unit that makes the second output unit continue to output the image signal, and stops the image signal of the first output unit when the detecting unit detects the detachment of the portable apparatus. According to the present invention, the image signal is not output to the first output unit in the case that the portable apparatus is detached from the electronic apparatus. Therefore, it is possible to suppress a short circuit of the first output unit, the breakage of the electronic apparatus, the noise leakage from the first output unit, and the like. In addition, the image can be watched on the display apparatus except the portable apparatus because the image signal is output to the display except the portable apparatus.

In the above composition, the image processing unit may include a switch that blocks the output of the image signal to the first output unit.

The present invention is an electronic system including a portable apparatus having a display, and an electronic apparatus from which the portable apparatus can be detached the electronic system characterized in that the electronic apparatus including: a first output unit that outputs an image signal to the portable apparatus; a second output unit that outputs an image signal to a display different from the portable apparatus; a detecting unit that detects a detachment of the portable apparatus; and an image processing unit that makes the second output unit continue to output the image signal, and stops the image signal of the first output unit when the detecting unit detects the detachment of the portable apparatus. According to the present invention, it is possible to suppress the breakage of the electronic apparatus and the noise leakage. In addition, the image can be watched on the display apparatus except the portable apparatus.

### EFFECTS OF THE INVENTION

According to the present invention, the image signal is not output to the first output unit when the portable apparatus having a display portion is detached from the in-vehicle apparatus. Therefore, the short circuit of the first output unit, the breakage of the electronic apparatus, and the noise leakage from the first output terminal can be suppressed. In addition, the image signal is output to the display apparatus except the portable apparatus, the image can be watched on the display apparatus except the portable apparatus.

### BRIEF DESCRIPTION OF THE DRAWINGS

FIG. 1A and FIG. 1B are schematic views illustrating an exterior appearance of an in-vehicle system in accordance with the first embodiment;

FIG. 2 is a schematic view of a portable apparatus taken out of an in-vehicle apparatus;

FIG. 3 is a schematic view illustrating a state of tilting a front face portion against the main body of the in-vehicle apparatus to expose a CD insertion/ejection slot;

FIG. 4 is a schematic view illustrating an example of mounting the in-vehicle system in a vehicle;

FIG. 5 is a block diagram illustrating a schematic configuration of the in-vehicle system;

FIG. 6 is a front face view of the main portion;

FIG. 7A through FIG. 7D are schematic views of display examples of the portable apparatus attached to the main portion;

FIG. 8A is a front schematic view, a top schematic view, bottom schematic view, left side schematic view, and right side schematic view of the portable apparatus, and FIG. 8B is a back schematic view of the portable apparatus;

FIG. 9 is a block diagram illustrating selected main blocks;

FIG. 10 is a flowchart illustrating a control of the controller; and

FIG. 11 is a block diagram illustrating selected main blocks in accordance with the second embodiment.

### BEST MODES FOR CARRYING OUT THE INVENTION

A description will now be given, with reference to the accompanying drawings, of exemplary embodiments of the present invention.

### First Embodiment

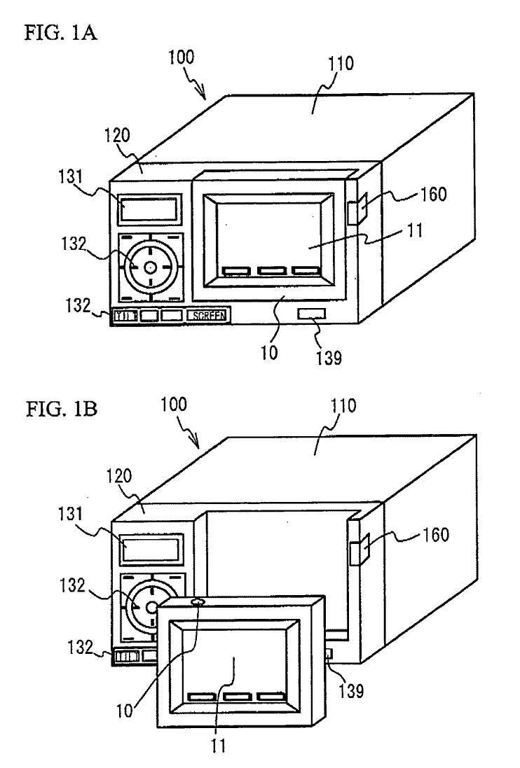

FIG. 1A and FIG. 1B illustrate exterior views of an in-vehicle system 1 (an electronic system), as an example of an electronic apparatus. As illustrated in FIG. 1A and FIG. 1B, the in-vehicle system 1 is composed of: an in-vehicle apparatus 100 (electronic apparatus); and a portable apparatus 10 (portable apparatus) with navigation capabilities. The portable apparatus 10 can be used after being attached at a front face portion 120 of the in-vehicle apparatus 100, as illustrated in FIG. 1A, and can be also used after being detached from the in-vehicle apparatus 100, as illustrated in FIG. 1B. As described above, the portable apparatus 10 can be attached to and detached from the in-vehicle apparatus 100, and it is possible to attach the portable apparatus 10 to the in-vehicle apparatus 100.

The in-vehicle apparatus 100 is capable of playing radio broadcasting and TV broadcasting or playing music data recorded on a memory medium such as a DVD (Digital Versatile Disc), CD (Compact Disc) or the like, and the in-vehicle apparatus 100 includes: an in-vehicle apparatus main body 110 having a DVD/CD player and a DVD/CD insertion/ejection slot; and the front face portion 120 having a display portion 131 and an operating portion 132. The portable apparatus 10 has navigation capabilities of searching for a guiding path to a destination and displaying the searched guiding path over a map.

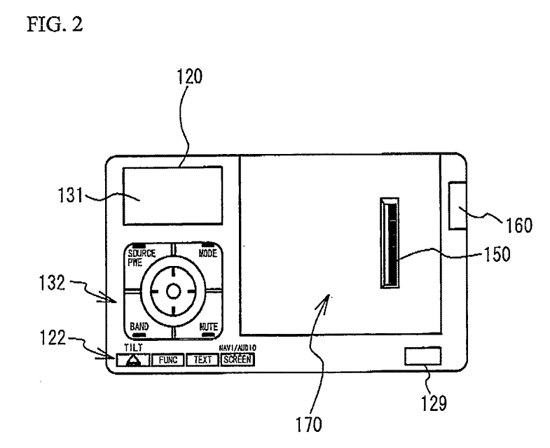

FIG. 2 illustrates the portable apparatus 10 taken out of the in-vehicle apparatus 100. There is provided a detaching-attaching portion 170 in which a recess portion is defined for attaching the portable apparatus 10, at the front face portion 120 of the in-vehicle apparatus 100. The top side of the detaching-attaching portion 170 is opened. The detaching-attaching portion 170 is provided with: a connector 150 for electrically coupling the in-vehicle apparatus 100 and the portable apparatus 10; and a lock mechanism (not illustrated) for securing the portable apparatus 10 to the front face portion 120. When a detach button 160 provided at the front face portion 120 is operated, a lock mechanism, not illustrated, is unlocked and the portable apparatus 10 is detachable from the in-vehicle apparatus 100.

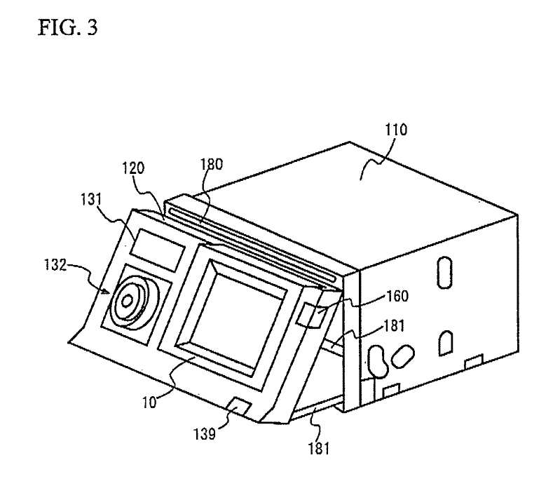

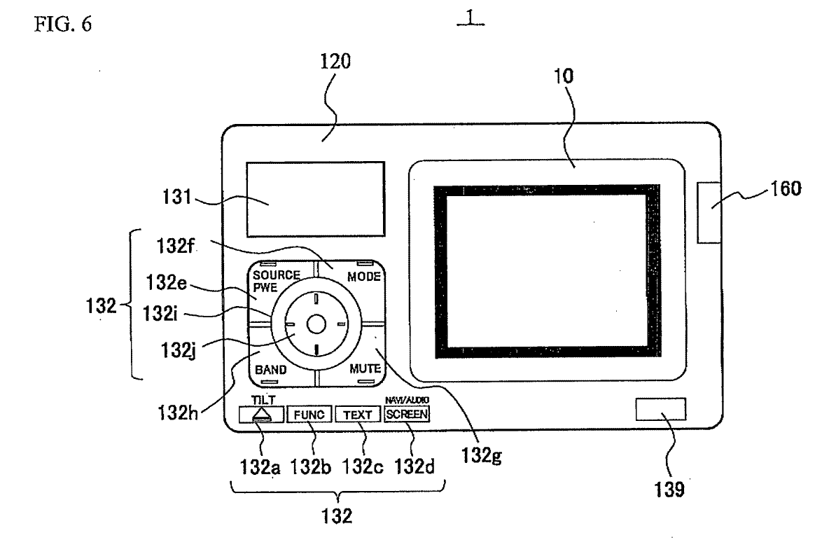

FIG. 3 illustrates a state of tilting the front face portion 120 against the in-vehicle apparatus main body 110 to expose a DVD/CD insertion/ejection slot 180. By driving a slider 181 illustrated in FIG. 3 with a drive mechanism, not illustrated, the front face portion 120 can be tilted (displaced) against the in-vehicle apparatus main body 110. By tilting operation, the DVD/CD insertion/ejection slot 180 provided in the in-vehicle apparatus main body 110 is exposed, so a DVD or CD can be inserted or ejected. There is provided an operation button (a tilt/eject button 132a illustrated in FIG. 6), at the front face portion 120 of the in-vehicle apparatus, and a tilt angle can be set according to the operation of this button.

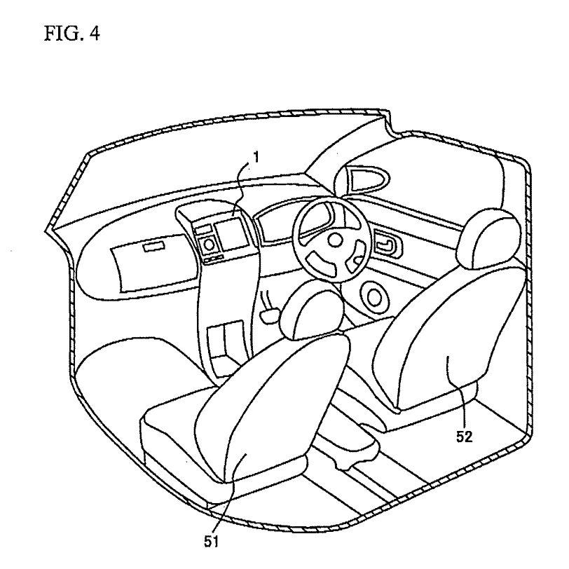

FIG. 4 illustrates an example of mounting the in-vehicle system 1 in a vehicle. The in-vehicle system 1 is disposed in a dashboard portion substantially in the middle of a driver's seat 52, and a front-passenger's seat 51, as illustrated in FIG. 4, for example. Here, a GPS antenna, not illustrated, of a GPS information receiver 133 described later is located on the dashboard or attached at an inner side of a front glass. In addition, a rear seat display portion 204 described later, not illustrated, is located on a ceiling, or a headrest of a front seat in the vehicle, for example.

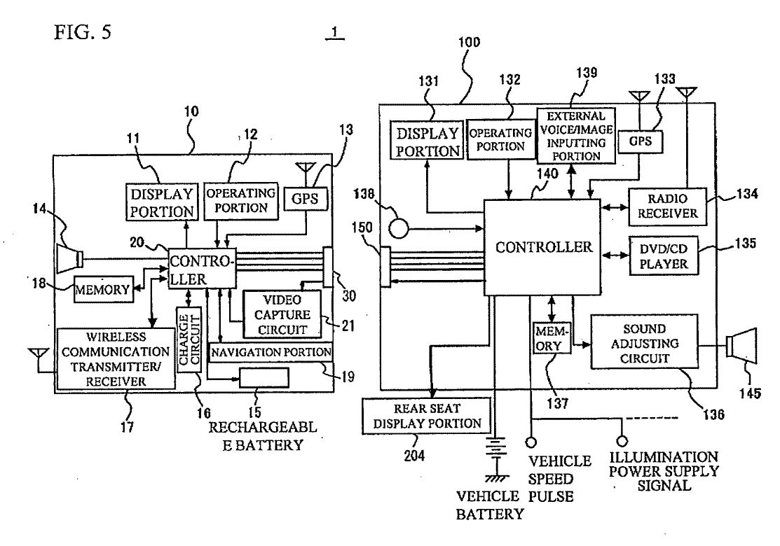

FIG. 5 is a block diagram illustrating a schematic configuration of the in-vehicle system 1. The in-vehicle apparatus 100 and the portable apparatus 10 are electrically connected by connectors. The connector 150 is provided at the in-vehicle apparatus 100 side, and a connector 30 is provided at the portable apparatus 10. By connecting the connector 150 and the connector 30, various signals are sent and received between the in-vehicle apparatus 100 and the portable apparatus 10 to function as the in-vehicle system 1. The connector 150 and the connector 30 are respectively provided with power supply terminals for supplying power to the portable apparatus 10 from the battery of the vehicle. When the portable apparatus 10 is connected to the in-vehicle apparatus 100 and the power is supplied to the in-vehicle apparatus 100, the power is also supplied to the portable apparatus 10 via the power supply terminals.

The in-vehicle apparatus 100 is provided with: the display portion 131; the operating portion 132; the GPS information receiver 133; a radio/TV receiver 134; a DVD/CD player 135; a sound adjusting circuit 136; a memory 137; a microphone 138; an external voice/image inputting portion 139; a controller 140; and the connector 150. The in-vehicle apparatus 100 is activated by supplying the power from the battery of the vehicle, when the engine key is positioned at ACC or ON.

Hereinafter, the function of each part will be described in detail. The display portion 131 is provided with a liquid crystal panel and a backlight, and displays a frequency of the received broadcasting, a track number of music being played, a music name being played, and the like, according to the 13-segment display. The operating portion 132 is provided for selectively changing the operation mode of the in-vehicle apparatus 100, and for operating in various modes that have been changed. The operating portion 132 is provided with a group of buttons including: the tilt/eject button 132 a function (represented as FUNC hereinafter)/AF button 132b; a TEXT button 132c; a SCREEN button 132d; a SOURCE/POWER button 132e; a MODE button 132 a MUTE button 132g; a BAND change button 132h; a rotary button 132i; a cross key/enter key button 132j, as illustrated in FIG. 6.

Herein, a description will be given of the control by operations of a group of buttons. Firstly, the description will be given of switching the display between the portable apparatus 10 and the in-vehicle apparatus 100 by the operation of the SOURCE/POWER button 132e. The in-vehicle apparatus 100 turns on when the SOURCE/POWER button 132e of the in-vehicle apparatus 100 is pushed. When the SOURCE/POWER button 132e is pushed for a short period of time while the portable apparatus 10 is on, the source is changed to the CD playing, DVD playing, radio broadcasting or TV broadcasting. At this time, the information on the selected source is displayed on the display portion 131 of the in-vehicle apparatus 100, and the navigation image is displayed on a display portion 11 of the portable apparatus 10, without relation to the source. Next, when the SCREEN button 132d is pushed, the navigation image displayed on the display portion 11 of the portable apparatus 10 can be changed to an image corresponding to the source selected at the in-vehicle apparatus 100.

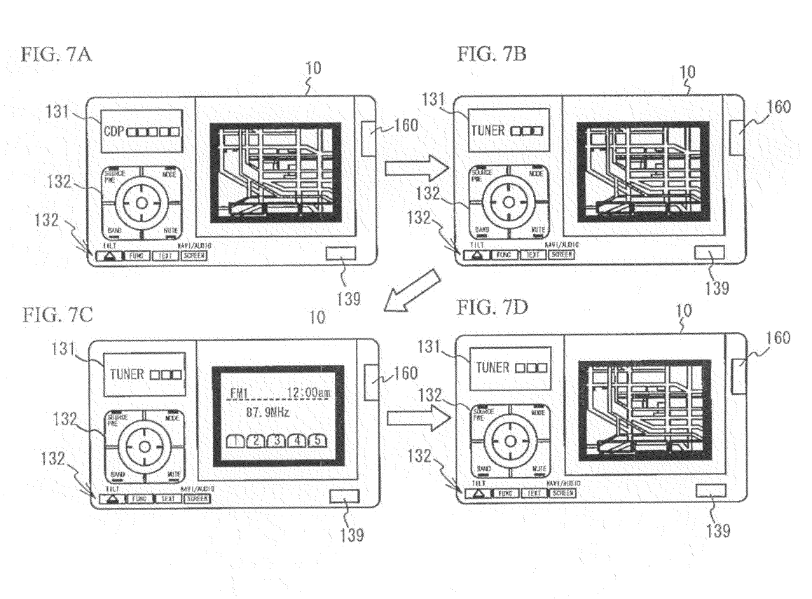

FIG. 7A illustrates a state where the portable apparatus 10 is attached to the in-vehicle apparatus 100 while the CD is being played and a navigation image is being displayed on the portable apparatus 10. When the SOURCE/POWER button 132e is pushed in the state of FIG. 7A and the source is changed from the CD playing to the radio broadcasting, the information on the radio source is displayed on the display portion 131, as illustrated in FIG. 7B. Also, the navigation image remains being displayed on the display portion 11 of the portable apparatus 10. Then, when a user pushes the SCREEN button 132d, the image corresponding to the source being processed by the in-vehicle apparatus 100 is displayed on the display portion 11 of the portable apparatus 10, as illustrated in FIG. 7C (radio image is displayed in FIG. 7C). A touch panel, described later, is provided in the display portion 11 of the portable apparatus 10. A user is capable of operating the source currently being processed, by selecting the operation buttons displayed on the display portion 11.

In addition, when the SCREEN button 132d is pushed with the radio screen being displayed on the display portion 11, it is possible to return to the navigation image from the radio image, as illustrated in FIG. 7D. When the portable apparatus 10 is detached from the in-vehicle apparatus 100, the operation of the SCREEN button 132d is invalid. Furthermore, when a USB (Universal Serial Bus) or the like is connected to the external voice/image inputting portion 139 with the portable apparatus 10 detached from the in-vehicle apparatus 100, it is possible to prevent the change to the USB source, even if the SOURCE/POWER button 132e is pushed.

Next, a description will be given of a tilt behavior of the front face portion 120 according to the operation of the tilt/eject button 132a. When the tilt/eject button 132a is operated in the first mode (e.g. pushed for a short period of time), the front face portion 120 is tilted at the angle at which the DVD/CD insertion/ejection slot 180 is exposed (e.g.) 60°, and when it is operated in the second mode (e.g. pushed for a long period of time), the front face portion 120 tilts by a predetermined angle (e.g. 5°).

Referring back to FIG. 5, the GPS information receiver 133 includes a GPS antenna and a tuner, and receives GPS signals from a satellite. The GPS signal received by the GPS information receiver 133 is output through the controller 140, the connector 150, the connector 30, and a controller 20, to a navigation portion 19 of the portable apparatus 10, and then the position of the vehicle in which the in-vehicle apparatus 100 having the portable apparatus 10 therein is determined based on the GPS signal. Here, the GPS signal received by the GPS information receiver 133 may be output to the navigation portion of the portable apparatus 10 through the controller 20, instead of through the controller 140. Alternatively, the GPS information receiver 133 may be composed of the GPS antenna only, so that the GPS signal received by the GPS antenna may be output to the tuner of a GPS information receiver 13, described later, without through the controller 140 or the controller 20. Various changes may be made as necessary.

The radio/TV receiver 134 has an antenna and a tuner, receives broadcast waves such as AM broadcasting, FM broadcasting, sound multiplex broadcasting, and TV broadcasting, receives and demodulates stereo audio signals, image signals and multiplex data, and outputs the demodulated signal to the controller 140. The DVD/CD player 135 reproduces the data stored in the DVD or CD, and outputs the reproduced signal to the controller 140. Herein, the demodulated signal output from the radio/TV receiver 134 may be output to the sound adjusting circuit 136, described later, without through the controller 140. The image data is transmitted to both the portable apparatus 10 and the rear seat display portion 204.

The sound adjusting circuit 136 implements signal processing such as volume control or tone control on the sound signal received or demodulated by the radio/TV receiver 134 or the sound signal reproduced by the DVD/CD player 135, and then outputs the processed signal to a speaker 145. The memory 137 may be composed of a RAM (Random Access Memory) from which data is readable and into which data is writable, and temporarily stores information necessary for control. The microphone 138 is provided for hands-free communication, and takes in user's voices in the vehicle. The external voice/image inputting portion 139 (attaching portion) is provided with a connection terminal with an external device such as a USB memory, portable audio device, or the like so that an audio signal or data from the external device may be input. The external voice/image inputting portion 139 then sends the signal or data to the controller 140, and outputs the control signal from the controller 140, the audio signal, data, or the like to the external device connected.

The controller 140 controls the radio/TV receiver 134, the DVD/CD player 135, and the sound adjusting circuit 136, according to the operation by means of the operating portion 132. Also, the controller 140 outputs various signals through the connector 150 to the portable apparatus 10, and controls the in-vehicle apparatus 100 on the basis of the various signals input from the portable apparatus 10. For example, the controller 140 outputs the GPS signal received by the GPS information receiver 133 or the audio signal input through the microphone 138, to the portable apparatus 10 by way of the connector 150. Here, the audio signal input through the microphone 138 may be output to the portable apparatus 10 by way of the connector 150, without through the controller 140. In addition, the voice on communication over a mobile phone connected to the portable apparatus 10 is input through the connector 150 into the controller 140, and is then output through the sound adjusting circuit 136 to the speaker 145. Furthermore, the controller 140 acquires an operation signal corresponding to a menu image of various modes displayed on the display portion 11 of the portable apparatus 10, from the controller 20 of the portable apparatus 10, and then controls the radio/TV receiver 134 and the DVD/CD player 135.

Also, the power is supplied to the controller 140 from the battery mounted in the vehicle. When the portable apparatus 10 is connected, the controller 140 outputs the power supplied from the battery to the portable apparatus 10. Herein, a vehicle speed pulse and an illumination power supply signal are input into the controller 140 from a vehicle. The controller 140 transfers such input vehicle speed pulse to the controller 20 of the portable apparatus 10. Meanwhile, the vehicle speed pulse may be configured not to be input into the in-vehicle apparatus 100.

Next, a description will be given of the portable apparatus 10. The portable apparatus 10 is provided with: the display portion 11; an operating portion 12; the GPS information receiver 13; a speaker 14; a rechargeable battery 15; a charge circuit 16; a wireless communication transmitter/receiver 17; a memory 18; the navigation portion 19; the controller 20; a video capture circuit 21; and the connector 30.

Hereinafter, functions of the components will be described in detail. The display portion 11 is provided with a liquid crystal panel and a backlight, and is capable of displaying map information generated by the navigation portion 19 and guiding path information to a destination, the received broadcasting frequency transferred from the in-vehicle apparatus 100, a music track number played, music name played, TV images, DVD images and the like. The image data is input to the controller 20 through the video capture circuit 21. The display portions 11 and 131 may employ a flat panel display other than a liquid crystal panel. Examples are organic light emitting display, plasma display panel, cold-cathode flat panel display, or the like.

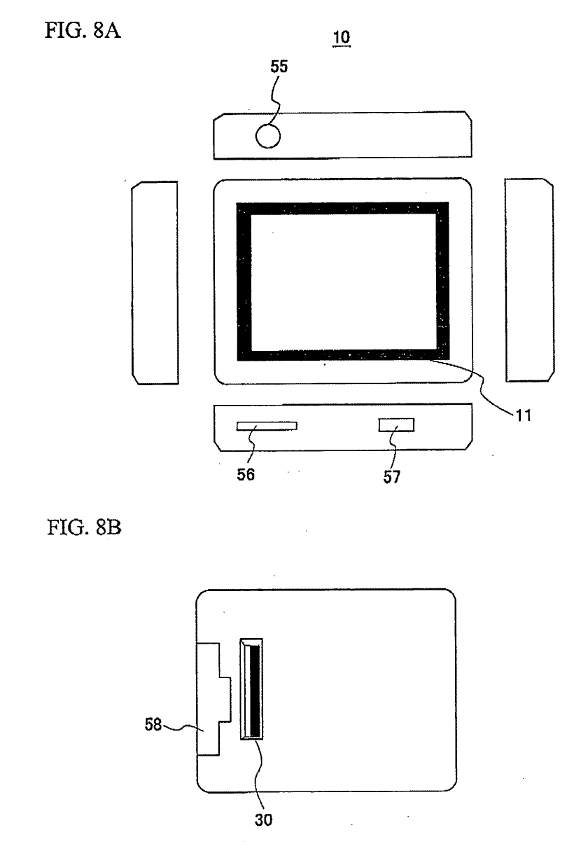

The operating portion 12 includes a power button 55 (see FIG. 8A) to turn on or off the power of the portable apparatus 10. The touch panel is, for example, disposed on the display screen of the display portion 11. When the touch panel is touched by a finger or a dedicated pen, the touched position is detected to determine whether or not there is an input operation. The power button 55 will be described later.

The GPS information receiver 13 includes an antenna and a tuner, and receives the GPS signal from a satellite. Such received GPS signal is output to the navigation portion 19, and the vehicle location is detected based on the GPS signal. Meanwhile, the in-vehicle apparatus 100 is also provided with the GPS information receiver 133. However, when the portable apparatus 10 is attached to the in-vehicle apparatus 100, the location of the vehicle in which the in-vehicle apparatus 100 having the portable apparatus 10 therein is mounted is specified by use of the GPS signal (and the vehicle speed pulse) received by the GPS information receiver 133. When the portable apparatus 10 is used alone, the location thereof is specified by use of the GPS signal received by the GPS information receiver 13.

The speaker 14 is provided for outputting the audio information of the navigation portion 19, and outputs the audio information only when the portable apparatus 10 is detached from the in-vehicle apparatus 100, namely, used-alone separately.

The rechargeable battery 15 supplies power to each portion of the portable apparatus 10. When the portable apparatus 10 is attached to the in-vehicle apparatus 100, the power is supplied through the power supply terminals of the connector 30 from the battery of the vehicle and the rechargeable battery 15 is charged by the charge circuit 16. Also, the charge circuit 16 is supplied with the power from the connection terminal through a USB slot (see FIG. 8A), and the rechargeable battery 15 can be charged.

The wireless communication transmitter/receiver 17 sends and receives the voice on communication over a mobile phone, and acquires the information used for navigation over the mobile phone. For example, Bluetooth, which is a wireless transmission system at 2.4 GHz band, is used for the wireless communication transmitter/receiver 17.

The memory 18 may be a RAM from which data is readable and into which the data is writable, and temporarily stores the information read for each control.

The navigation portion 19 includes a map information storing portion in which the map information used for navigation acquired from an SD card or the USB memory, described later, is stored, determines current location information with GPS signal from the GPS information receiver 133 or the CPS information receiver 13, and creates an image for the navigation operation. The created map may be displayed on the display portion 11. When the in-vehicle apparatus 100 and the portable apparatus 10 are connected, the vehicle speed pulse is acquired from the vehicle so that the accuracy of the location detection of the vehicle in which the portable apparatus 10 is mounted in the in-vehicle apparatus 100 can be improved. Here, the map information may be retained in the portable apparatus 10.

The controller 20 controls each part of the portable apparatus 10. Also, the controller 20 outputs various signals to the in-vehicle apparatus 100 through the connector 30, and controls the portable apparatus 10 based on the various signals input from the in-vehicle apparatus 100. For example, the controller 20 acquires the GPS signal received by the CPS information receiver 133 of the in-vehicle apparatus 100 and the vehicle speed pulse from the controller 140 of the in-vehicle apparatus 100, and outputs the GPS signal and the vehicle pulse to the navigation portion 19. Also, the controller 20 acquires the audio signal input by the microphone 138 of the in-vehicle apparatus 100 from the controller 140 of the in-vehicle apparatus 100, and controls the navigation portion 19 according to the audio signal. That is to say, the navigation portion 19 can be operated in a hands-free manner. The voice on communication over the mobile phone connected to the wireless communication transmitter/receiver 17 is output to an in-vehicle apparatus side through the connector 30, and is caused to output from the speaker 145 of the in-vehicle apparatus 100. The operation signal on the menu screen or content screen displayed on the display portion 11 is output to the controller 140 of the in-vehicle apparatus 100 through the connector 30. The controller 140 controls the radio/TV receiver 134 or the DVD/CD player 135 according to the operation signal transmitted from the controller 20 of the portable apparatus 10.

FIG. 8A illustrates a front view, top view, bottom view, left-side view, and right-side view of the portable apparatus 10. FIG. 8B is a back view of the portable apparatus 10. The top face of the portable apparatus 10 is provided with the power button 55 for turning on or off the power of the portable apparatus. The bottom face of the portable apparatus 10 is provided with: an SD (Secure Digital) memory card slot 56; and a USB slot 57. By inserting the SD card or the USB memory, in which the map information is stored, into the slots, the controller 20 reads out the map information from the SD card or the USB memory and outputs the map information to the navigation portion 19.

The power of the portable apparatus 10 is turned on or off on basis of control from the in-vehicle apparatus 100, when the portable apparatus is attached to the in-vehicle apparatus 100. Also, the power is operated on the basis of on or off operation of the power button 55, when the portable apparatus 10 is detached from the in-vehicle apparatus 100 and used alone separately.

Furthermore, on the back side of the portable apparatus 10, there are provided the connector 30 for establishing electrical connection with the in-vehicle apparatus 100 and a latch portion 58 latched with a lock mechanism (not illustrated) provided at the in-vehicle apparatus 100 side.

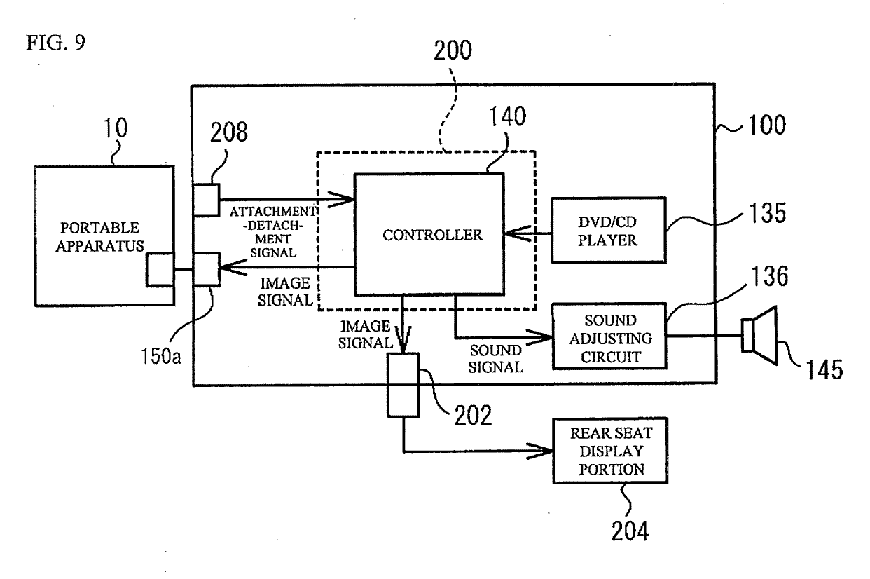

Hereinafter, the detail of the first embodiment will be described. FIG. 9 is a block diagram illustrating main blocks selected from FIG. 5 with an emphasis on flow of image signals. Referring to FIG. 9, the in-vehicle apparatus 100 is provided with: an image processing portion 200 (an image processing unit) including the controller 140, the DVD/CD player 135, the sound adjusting circuit 136, a first output terminal 150a (a first output unit) and a second output terminal 202 (a second output unit).

Data output from the DVD/CD player 135 is processed into the image signal and the sound signal such as NTSC signal or PAL signal in the controller 140. The sound signal is output to the speaker 145 through the sound adjusting circuit 136. Accordingly, the user can hear the sound in the vehicle.

A DVD image signal is output to the portable apparatus 10 through the first output terminal 150a which is a part of the connector 150. As described, the first output terminal 150a outputs the image signal to the portable apparatus 10. On the other hand, the same image signal is output to the rear seat display portion 204 through the second output terminal 202. As described, the second output terminal 202 outputs the image signal to the rear seat display portion 204. Accordingly, when the portable apparatus 10 is attached to the in-vehicle apparatus 100, the user can watch the reproduced DVD image on both the display portion 11 of the portable apparatus 10 and the rear seat display portion 204. A detecting portion 208 (a detecting unit) is a sensor that detects the attachment and detachment of the portable apparatus 10, and outputs an attachment-detachment signal which indicates the attachment and detachment of the portable apparatus 10 to the controller 140.

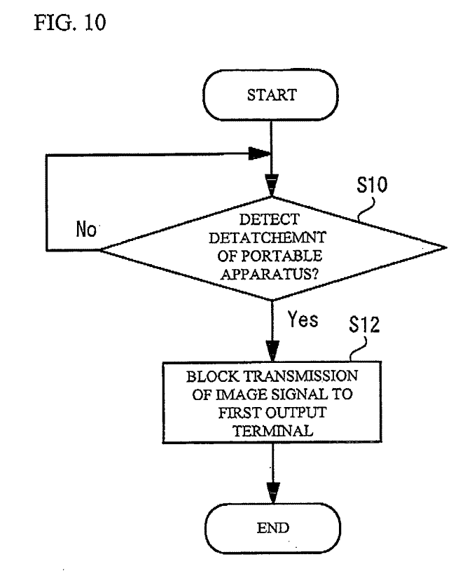

FIG. 10 is a flowchart illustrating the control of the controller 140. This flowchart starts when the reproduced (demodulated) image signal such as a DVD image or a TV image can be transmitted to the portable apparatus 10 through the first output terminal 150a after the SCREEN button 132e described before is operated while the portable apparatus 10 is attached to the in-vehicle apparatus 100. The same image signal can be transmitted to the rear seat display portion 204 through the second output terminal 202, and the sound signal is adjusted by the sound adjusting circuit 136, and can be sent to the speaker 145. In this state, the controller 140 receives the attachment-detachment signal from the detecting portion 208, and determines whether the attachment-detachment signal is a signal indicating the detachment of the portable apparatus 10 (step S10). When the determination is No, the process is goes back to the step S10. This means that the controller 140 transmits the image signal to the portable apparatus 10 through the first output terminal 150a, and to the rear seat display portion 204 through the second output terminal 202. When the determination in the step S10 is Yes, the controller 140 blocks the transmission of the image signal to the first output terminal 150a (step S12). This means that the controller 140 transmits the image signal to the rear seat display portion 204 through the second output terminal 202, and does not transmit the image signal to the first output terminal 150a.

As described in the steps S10 and S12 in FIG. 10, when the detecting portion 208 detects the detachment of the portable apparatus 10, the controller 140 makes the second output terminal 202 continue to output the image signal, and stops the image signal of the first output terminal 150a. Accordingly, when the portable apparatus 10 is detached from the in-vehicle apparatus 100, the image signal is not output to the first output terminal 150a. Therefore, the breakage of the controller 140 caused by the short circuit between terminals in the first output terminal 150a, and the noise leakage from the first output terminal 150a can be suppressed. In addition, the user seating on the rear seat can watch the image because the image signal is transmitted to the rear seat display portion 204.

It is preferable that the controller 140 outputs the sound signal to the speaker 145 (a sound output portion) regardless of whether the detecting portion 208 detects the detachment of the portable apparatus 10, because the sound is output from the speaker 145 in the vehicle.

As described in FIG. 2, when the connector 150 including the first output terminal 150a is exposed to the front while the portable apparatus 10 is detached, there is possibility that conductive goods contact the connector 150. This means that the inside of the in-vehicle apparatus 100 can break easily. In addition, the noise easily leaks from the connector 150. Therefore, using compositions according to the first embodiment is beneficial.

### Second Embodiment

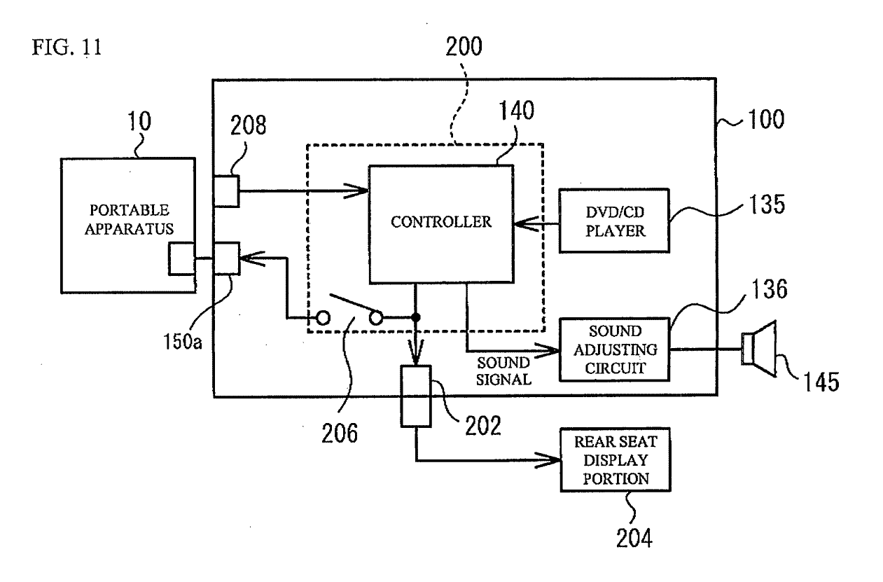

FIG. 11 is a block diagram illustrating an in-vehicle system in accordance with the second embodiment. As illustrated in FIG. 11, an image processing portion 200a is provided with a switch 206 besides the controller 140. The switch 206 blocks the output of the image signal to the first output terminal when the detecting portion 208 detects the detachment of the portable apparatus 10. As described, the same benefit as the first embodiment can be provided by using the switch 206.

In the first embodiment and the second embodiment, the description is given with the example that the display portable apparatus is a Portable Navi (a portable navigation apparatus). However, the display portable apparatus may be a portable apparatus that displays an image. In addition, the description was given with the example that the image data is data output from the DVD/CD player 135. However, the image data may be data output from a tuner, a video tape recorder, a memory card, and the like. In the first embodiment and the second embodiment, the description was given with the in-vehicle apparatus, but this does not limit the scope of the application of the present invention.

The present invention is not limited to the specifically described embodiments and variations, but other embodiments and variations may be made without departing from the scope of the present invention.

1. An electronic apparatus from which a portable apparatus having a display portion can be detached, the electronic apparatus comprising:
a first output unit that outputs an image signal to the portable apparatus;
a second output unit that outputs an image signal to a display apparatus different from the portable apparatus;
a detecting unit that detects a detachment of the portable apparatus; and
an image processing unit that makes the second output unit continue to output the image signal, and stops the image signal of the first output unit when the detecting unit detects the detachment of the portable apparatus.

2. The electronic apparatus according to claim 1, wherein the image processing unit includes a switch that blocks the output of the image signal to the first output unit.

3. An electronic system including a portable apparatus having a display, and an electronic apparatus from which the portable apparatus can be detached, the electronic apparatus comprising:
a first output unit that outputs an image signal to the portable apparatus;
a second output unit that outputs an image signal to a display different from the portable apparatus;
a detecting unit that detects a detachment of the portable apparatus; and
an image processing unit that makes the second output unit continue to output the image signal, and stops the image signal of the first output unit when the detecting unit detects the detachment of the portable apparatus.

4. The electronic apparatus according to claim 1, wherein the electronic apparatus is an in-vehicle electronic apparatus.
